(19) United States
(12) Patent Application Publication
(10) Pub. No.: US 2014/0073362 A1
(43) Pub. Date: Mar. 13, 2014

(54) INFORMATION PROCESSING APPARATUS, INFORMATION PROCESSING METHOD, PROGRAM, AND INFORMATION PROCESSING SYSTEM

(71) Applicant: Sony Corporation, Tokyp (JP)

(72) Inventors: Shogo Kawata, Tokyo (JP); Shigefumi Tamura, Tokyo (JP); Megumi Kikuchi, Tokyo (JP)

(73) Assignee: Sony Corporation, Tokyo (JP)

(21) Appl. No.: 14/113,646

(22) PCT Filed: Apr. 30, 2013
(86) PCT No.: PCT/JP2013/002901

§ 371 Date: Oct. 24, 2013

(30) Foreign Application Priority Data
Jun. 27, 2012 (JP) 2012-143952

(51) Int. Cl. H04W 4/02

(52) U.S. Cl. CPC H04W 4/028
USPC 455/456.3

(57) ABSTRACT

There is provided an information processing apparatus including an acquisition unit configured to acquire information from a plurality of terminal nodes, an analysis unit configured to analyze the acquired information and generate route information for each individual one of the plurality of terminal nodes, and a grouping unit configured to group the plurality of terminal nodes based on the route information.

### TECHNICAL FIELD

The present disclosure relates to an information processing apparatus, an information processing method, a program, and an information processing system.

### BACKGROUND ART

In the related art, the following Patent Literature 1 discloses technology which considers implementing shared experience through a communication medium between users interested in the same media content.

### CITATION LIST

### Patent Literature

[PTL 1]
JP 2004-62812A

### SUMMARY

### Technical Problem

However, when considering that users interested in the same media content participate in an actual event, users remote from an event site may not be participating in the event. Furthermore, since users have various preferences, event information useful to some users may not be useful to other users. In the related art, it is difficult to provide optimal information according to the location of users and various characteristics of preferences and the like.

In this regard, it is necessary to provide event information according to the characteristics of users.

### Solution to Problem

According to an embodiment of the present disclosure, there is provided an information processing apparatus including an acquisition unit configured to acquire information from a plurality of terminal nodes, an analysis unit configured to analyze the acquired information and generate route information for each individual one of the plurality of terminal nodes, and a grouping unit configured to group the plurality of terminal nodes based on the route information.

Further, according to an embodiment of the present disclosure, there is provided an information processing method including acquiring information from a plurality of terminal nodes, analyzing the acquired information and generating route information for each individual one of the plurality of terminal nodes, and grouping the plurality of terminal nodes based on the route information.

Further, according to an embodiment of the present disclosure, there is provided a non-transitory computer-readable medium embodied with a program, which when executed by a computer, causes the computer to perform a method including acquiring information from a plurality of terminal nodes, analyzing the acquired information and generating route information for each individual one of the plurality of terminal nodes, and grouping the plurality of terminal nodes based on the route information.

Further, according to an embodiment of the present disclosure, there is provided an information processing apparatus including a reception unit that receives condition information of an event from a user terminal of a host, an invitation condition setting unit that sets an invitation condition for deciding a user able to be invited to the event based on the condition information, and a transmission unit that transmits information on the event to a terminal of a user based on the invitation condition.

Further, the invitation condition setting unit may calculate a score of a user based on a present position of the user, a venue of an event, and a time at which the event is to be held, and sets an invitation condition of the user based on the score.

Further, the invitation condition setting unit may calculate a score of a user based on preference information of the user and a type of an event, and sets an invitation condition of the user based on the score.

Further, the invitation condition setting unit may calculate a score of a user based on profile information of the user, and sets an invitation condition of the user based on the score.

Further, the invitation condition setting unit may calculate a score of a user based on a past event participation history of the user, and sets an invitation condition of the user based on the score.

Further, the invitation condition setting unit may set a user having the score equal to or more than a predetermined value as a participation candidate, and the transmission unit transmits information on an event to the user who is the participation candidate.

Further, when, based on a present position of a user, a venue of an event, and a time at which the event is to be held, the user is not predicted to reach the venue of the event at the time, the invitation condition setting unit does not set the user as a participation candidate.

Further, the information processing apparatus may further include a menu information transmission unit that transmits, to the user terminal, menu information used to allow a user to input the condition information of the event on the user terminal.

Further, the menu information may be used to allow a user to input a type of an event, a venue of the event, a start time of the event, an end time of the event, an age of a participant, a sex of the participant, a present position of the user, a future schedule of the user, or preference information of the user.

Further, the information processing apparatus may further include a reception unit that receives a response from a user terminal to which the transmission unit has transmitted information on an event, and a determination unit that determines whether the user satisfies condition information of the event based on the response.

Further, according to an embodiment of the present disclosure, there is provided an information processing method including receiving condition information of an event from a user terminal of a host, setting an invitation condition for deciding a user able to be invited to the event based on the condition information, and transmitting information on the event to a terminal of a user based on the invitation condition.

Further, according to an embodiment of the present disclosure, there is provided a program for causing a computer to execute functions of receiving condition information of an event from a user terminal of a host, setting an invitation condition for deciding a user able to be invited to the event based on the condition information, and transmitting information on the event to a terminal of a user based on the invitation condition.

Further, according to an embodiment of the present disclosure, there is provided an information processing system including a user terminal that transmits condition information of an event, and an information processing apparatus including a reception unit that receives the condition information of the event from a user terminal of a host, an invitation condition setting unit that sets an invitation condition for deciding a user able to be invited to the event based on the condition information, and a transmission unit that transmits information on the event to a terminal of a user based on the invitation condition.

### Advantageous Effects of Invention

According to embodiments of this disclosure, it is possible to provide event information according to the characteristics of users.

### BRIEF DESCRIPTION OF DRAWINGS

FIG. 1 is a schematic view for explaining the overview of a first embodiment.

FIG. 2 is a schematic view illustrating the configuration of a system of the first embodiment.

FIG. 3 is a flowchart illustrating the flow of processes in a server, in accordance with embodiments.

FIG. 4 is a block diagram illustrating the configuration of a server, in accordance with embodiments.

FIG. 5 is a schematic view illustrating the configuration of a user terminal, in accordance with embodiments.

FIG. 6 is a schematic view illustrating the schematic configuration of a system in accordance with embodiments.

FIG. 7 is a sequence diagram illustrating processes of a second embodiment.

FIG. 8 is a schematic view illustrating an example of time position information (e.g., log) of a user A, which is provided to a server, in accordance with embodiments.

FIG. 9 is a schematic view illustrating an example of a time position information (e.g., log) database held by a server, in accordance with embodiments.

FIG. 10 is a flowchart illustrating a process of generating grouping information, in accordance with embodiments.

FIG. 11 is a block diagram illustrating the configuration of a server, in accordance with embodiments.

FIG. 12 is a schematic view illustrating an example of grouping information, in accordance with embodiments.

FIG. 13 is a schematic view illustrating an example of screen display based on grouping information, in accordance with embodiments.

FIG. 14 is a schematic view illustrating a route of a user A, in accordance with embodiments.

FIG. 15 is a schematic view illustrating the state in which detailed tune information of a user A has been thinned into spot data at a constant interval from information on the route illustrated in FIG. 14.

FIG. 16 is a schematic view illustrating the state in which a position has been divided into predetermined ranges and data of time and areas in which the users have stayed has been generated, in accordance with embodiments.

FIG. 17 is a schematic view illustrating data obtained by classifying user positions, in accordance with embodiments.

FIG. 18 is a schematic view illustrating route information of a user B together with route information of a user A, in accordance with embodiments.

FIG. 19 is a schematic view illustrating the state in which route information of a user B has been thinned, in accordance with embodiments.

FIG. 20 is a schematic view illustrating the state in which positions of users A and B have been divided into predetermined ranges, in accordance with embodiments.

FIG. 21 is a schematic view illustrating the state in which positions of users A and B have been divided into predetermined ranges and data of time and areas in which the users A and B have stayed has been generated, in accordance with embodiments.

FIG. 22 is a schematic view illustrating a calculation example of similarity, in accordance with embodiments.

FIG. 23 is a schematic view illustrating an example using similarity by hour according to the degree of proximity of areas, in addition to determination regarding whether the areas are equal to each other, in accordance with embodiments.

FIG. 24 is a schematic view illustrating an example using similarity by hour according to the degree of proximity of areas, in addition to determination regarding whether the areas are equal to each other, in accordance with embodiments.

FIG. 25 is a schematic view illustrating an example in which a correction coefficient according to the passage of time has been multiplied, in accordance with embodiments.

FIG. 26 is a flowchart illustrating processes of a third embodiment.

FIG. 27 is a block diagram illustrating the configuration of a server, in accordance with embodiments.

FIG. 28 is a schematic view illustrating the configuration of a user terminal, in accordance with embodiments.

### DESCRIPTION OF EMBODIMENTS

Hereinafter, embodiments of the present disclosure will be described in detail with reference to the appended drawings. Note that, in this specification and the appended drawings, structural elements that have similar function and structure are denoted with the same reference numerals, and redundant explanation of these structural elements is omitted.

Hereinafter, embodiments of the disclosure will be described in the following order.

1. Overview of Each Embodiment

2. First Embodiment
2.1. Overview of First Embodiment
2.2. System Configuration of First Embodiment
2.3. Process Flow of First Embodiment
2.4. Configuration Example of Server
2.5. Configuration Example of User Terminal
2.6. Community Formation Based on Event Already Fixed to Be Performed

3. Second Embodiment
3.1. Overview of Second Embodiment
3.2. System Configuration of Second Embodiment
3.3. Process of Second Embodiment
3.4. Process of generating Grouping Information
3.5 Configuration Example of Server
3.6. Example of Grouping Information
3.7. For Classification of Route Information Analysis

4. Third Embodiment
4.1. Overview of Third Embodiment
4.2. Process of Third Embodiment
4.3. Configuration Example of Server
4.4. Configuration Example of User Terminal
4.5. Message Delivery Technique to Grouped User
4.6. Use Example of Third Embodiment

### 1. Overview of Each Embodiment

In an automatic formation technique according to embodiments of the disclosure, a temporary community is formed based on information on the location of a user and time. In a first embodiment, a description will be provided for an aspect in which a community is formed using a temporary relation between a place and time. In a second embodiment, a description will be provided for an example in which a community is formed using a continuous pattern of a place and time. In a third embodiment, a description will be provided for an example in which users in the same environment are grouped.

### 2. First Embodiment

### 2.1. Overview of First Embodiment

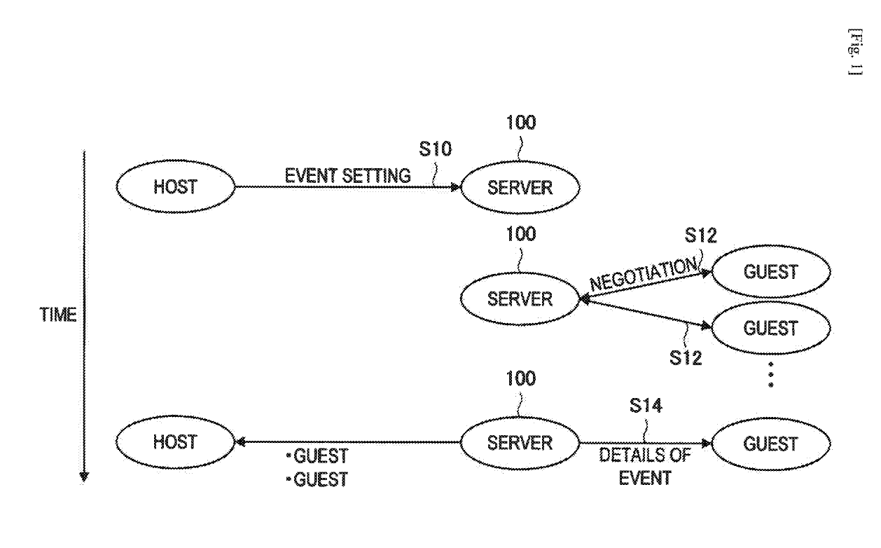

First, with reference to FIG. 1, the overview of the first embodiment of the present disclosure will be described. In the first embodiment, a community is formed using a temporary relation between a place and time. Furthermore, an event participation collection service will be described. In the event participation collection service, a host user (e.g., an event sponsor) may automatically collect participants according to conditions of a designated event, and transmit a notification to host guests of the event. In other words, this service relates to a member collection agent.

FIG. 1 is a schematic view illustrating processes of the event participation collection service in accordance with the first embodiment. In FIG. 1, in step S10, the host user sets an event in a server 100. Furthermore, the host user sets a place, a date and the like of the event, in which participants are gathered, in the server 100. The event, thr example, may include a soccer game, a concert, a party, and the like. In step S12, the server 100 negotiates with guests based on event conditions. In step S14, the server 100 notifies of guests who can participate in the event of details of the event.

### 2.2. System Configuration of First Embodiment

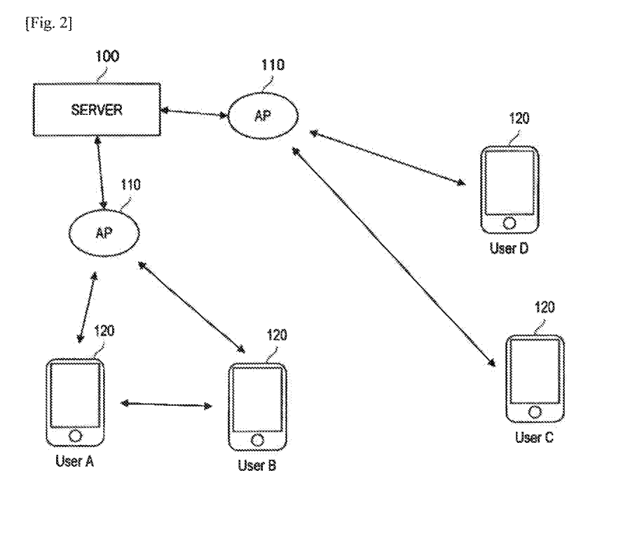

FIG. 2 is a schematic view illustrating the configuration of a system of the first embodiment. As illustrated in FIG. 2, the system of the first embodiment includes a server 100, an access point 110, and user terminals 120 (corresponding to users A, B, C, D, . . . ). A user communicates with the access point 110 through a radio communication network, thereby communicating with the server 100. The server 100, for example, may include a social network server (an SNS server) constituting a social network.

### 2.3. Process Flow of First Embodiment

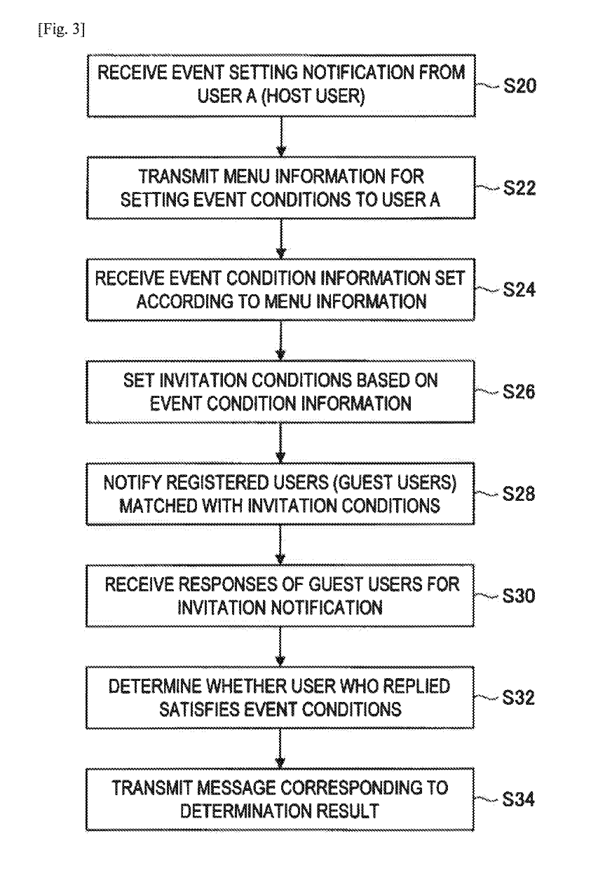

FIG. 3 is a flowchart illustrating the flow of processes in the server 100, in accordance with embodiments. First, in step S20, the server 100 receives an event setting notification from the user terminal 120 of the user A (e.g., the host user). In step S22, the server 100 transmits menu information for setting event conditions to the user terminal 120 of the user A. In step S24, the server 100 receives event condition information set by the user terminal 120 of the user A according to the menu information.

In more detail, in step S20 and S24, the host user inputs an event setting. First, the terminal 120 of the host user receives the event menu information transmitted from the server 100 in step S22. As the event menu information, for example, information including “sports,” “a drinking party,” “a free event” and the like is transmitted from the server 100 to the user terminal 120, the event menu information is displayed on a display screen of the user terminal 120. When the host user selects the “sports” from the event menu information, a menu of “a soccer,” “a baseball,” “fishing” and the like is further displayed among the event menu information.

When the user selects “soccer,” a screen is displayed in order to set a venue (e.g., a range), a time (e.g., start time, end time), a number of participants, ages of participants, sex, a present position of a user, a next scheduled route, a next schedule, preference information (e.g., a favorite event, such as a concert, watching sports, etc.) of a guest, and the like. The host user further selects these pieces of information. The information set by the user is defined as “event condition information.” The event condition information is transmitted from the user terminal 120 to the server 100.

In step S26, the server 100 sets invitation conditions based on the event condition information. Furthermore, the invitation conditions are set based on a present position of each guest, a future schedule and the like of the guest. For example, when it is detected that a guest is on a route back home and is positioned in the vicinity of a future place of an event to be held from an invitation schedule, the guest is recognized as being able to participate in the event. Then, the present position of the user, the future position, and the guest preference information are weighted to calculate a score for each guest from the following Equation, and a participation order is set. The preference information of the user is based on a registered profile (e.g., content written as a favorite thing), a past event participation history and the like. In addition, guests not satisfying minimum conditions are excluded. For example, when guests are considered not to be able to participate in an event to be held based on a present position, a future position and the like, the guests are excluded.

A calculation equation of the score may be provided as follows.

Score=W1*P1+W2*P2+W3*P3

In the equation above, P1 denotes a distance between a position on a guest schedule and a position of an event to be held. Furthermore, P2 denotes the degree of preference of a guest for an event. Furthermore, P3 denotes the degree of coincidence of an invited guest set by a host for profile information. Furthermore, W1, W2, and W3 denote weights (e.g., weighting coefficients) for each of the terms.

In step S28, the server 100 notifies registered users guest users) satisfying the invitation conditions of details of the event. Furthermore, a user having the aforementioned score equal to or more than a predetermined value is set as a user satisfying the invitation conditions, and is notified of the details of the event. In step S30, the server 100 receives responses of the guest users for the invitation notification. In step S32, the server 100 determines whether a user who has replied satisfies the event conditions. In step S34, the server 100 transmits a message corresponding to a result of the determination in step S32 to each user.

### 2.4. Configuration Example of Server

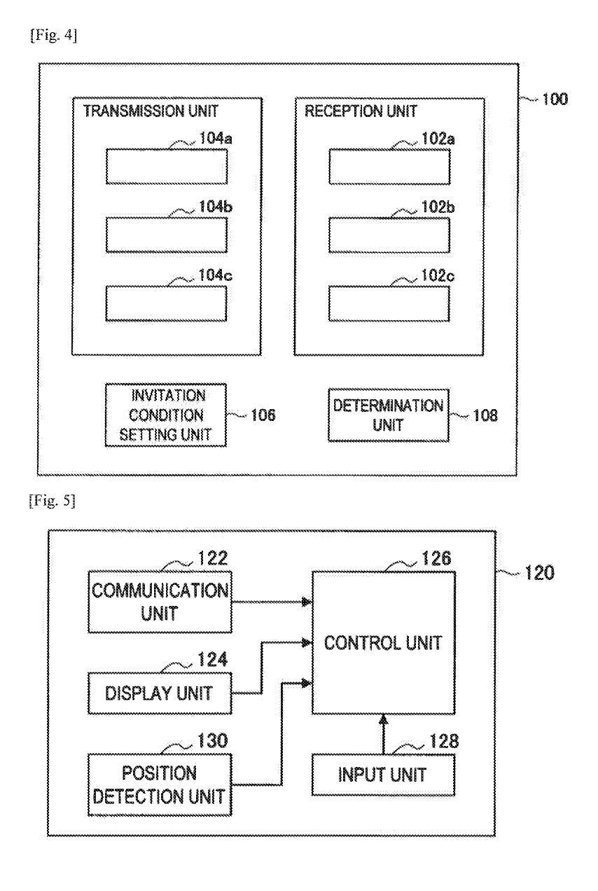

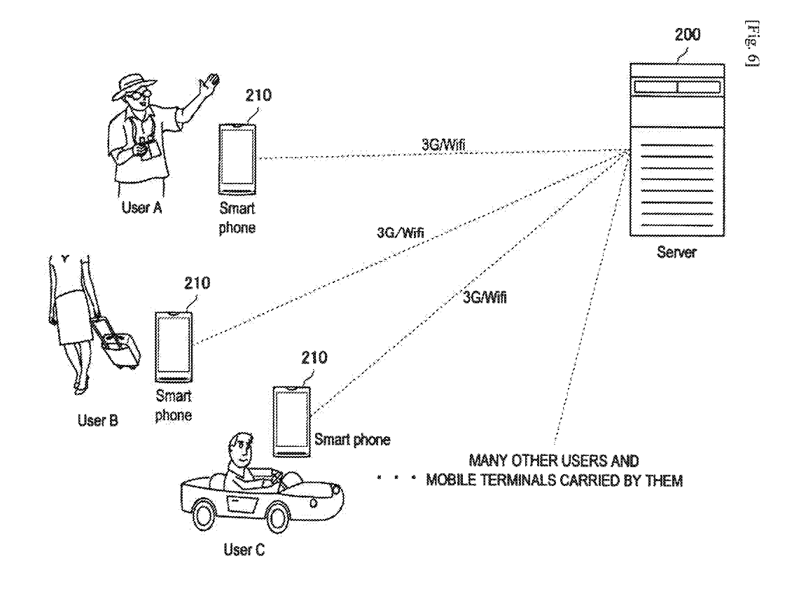

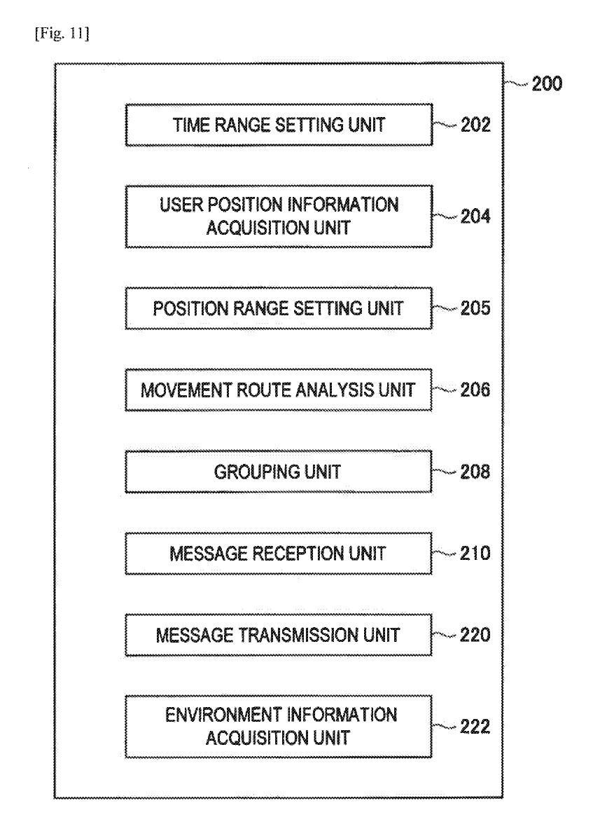

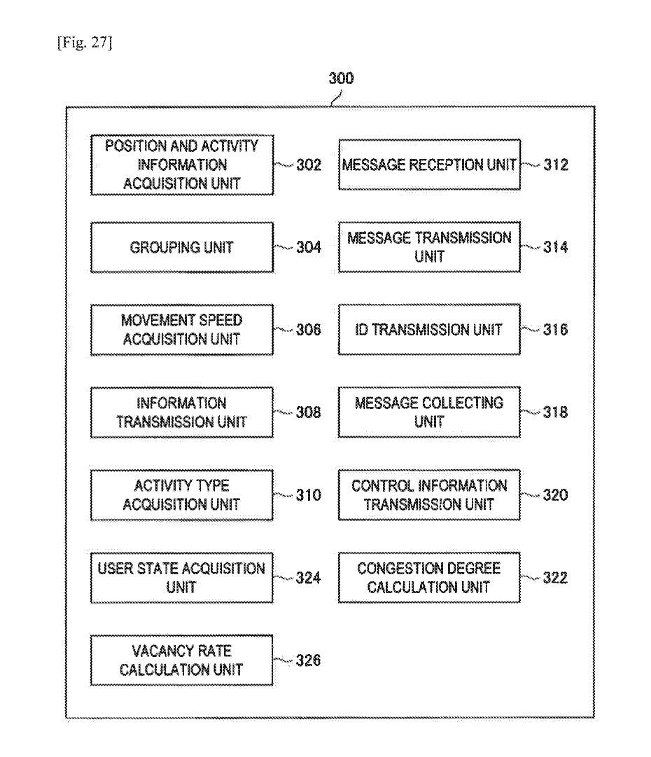

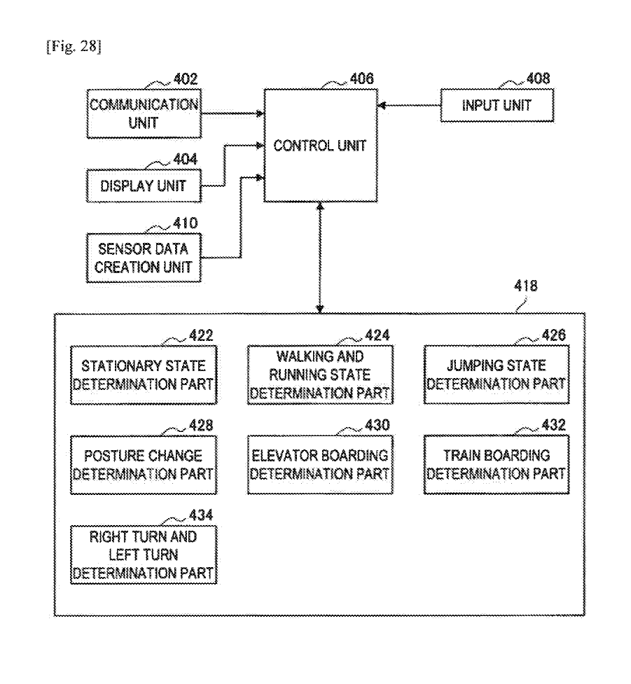

FIG. 4 is a block diagram illustrating the configuration of the server 100 that implements the aforementioned processes, in accordance with embodiments. The server 100 includes reception units 102a, 102b, and 102c, transmission units 104a and 104b, an invitation condition setting unit 106, and a determination unit 108. The reception unit 102a performs a process of receiving the event setting notification from the user terminal 120 in step S20 of FIG. 3. Furthermore, the reception unit 102b performs a process of receiving the event condition information of step S24. Furthermore, the reception unit 102c performs a process of receiving the response from the user satisfying the invitation conditions in step S30. The transmission unit 104a transmits the menu information in step S22. Furthermore, the transmission unit 104b performs a process of notifying the registered user satisfying the invitation conditions of the event information in step S28. The invitation condition setting unit 106 performs a process of setting the invitation conditions of step S26. In more detail, the invitation condition setting unit 106 calculates the score based on the position information of the user, the preference information, and the event information, and selects a user as an event participation candidate based on the score. The determination unit 108 determines whether the response received from the user matching the invitation conditions satisfies the event conditions in step S32. In addition, each element of the server 100 illustrated in FIG. 4 may include a circuit (e.g., hardware), or a CPU (central processing unit) and a program (e.g., software) for operating the CPU. In this case, the program may be stored in a storage unit provided in the server 100. In addition, configurations illustrated in FIG. 5, FIG. 11, FIG. 27, and FIG. 28 may also be configured in a similar manner.

### 2.5. Configuration Example of User Terminal

FIG. 5 is a schematic view illustrating the configuration of the user terminal 120, in accordance with embodiments. As illustrated in FIG. 5, the user terminal 120 includes a communication unit 122, a display unit 124, a control unit 126, an input unit 128, and a position detection unit 130. The communication unit 122 communicates with the server 100 through a radio communication network. The display unit 124 includes a liquid crystal display panel and the like, and displays various types of information on a display screen thereof based on an instruction from the control unit 126. The control unit 126 controls the entire user terminal 120. The input unit 128 includes buttons, a keyboard, a touch sensor and the like, and receives operation input from a user. The position detection unit 130, for example, includes a GPS, and acquires position information of the user terminal 120.

Each element of the server 100 and the user terminal 120 illustrated in FIG. 4 and FIG. 5 includes hardware (e.g., a circuit), or a central processing unit such as a CPU and a program (e.g., software) for operating the central processing unit. The program may be stored in a storage unit, such as a memory provided in the server 100 or the user terminal 120, or storage media inserted from an exterior, and may be downloaded to the server 100 or the user terminal 120 through a network such as the Internet.

### 2.6. Community Formation Based on Event Already Fixed to Be Performed

Next, community formation based on an event already fixed to be performed will be described. For example, the fact that a user has participated in the same event or has supported the same team may be regarded as a part of the event conditions. The host user sets conditions of a participant of an event performed in the past in conditions of a guest to be invited, as the event conditions. In detail, the type and the like of a team to be supported may also be set.

According to a technique for recognizing that the user has participated in the same event, when environment sound acquired from the user is similar environment sound (i.e., a cheering song), a strong connection is set in users having acquired the environment sound. In this case, this is because the users are considered to be highly likely to support the same team. Furthermore, a site may be recognized by superimposing a sound identification signal out of an audible range in a broadcasting wave.

Furthermore, the invitation order may be decided according to the following information. All the information is acquired by the user terminal 120 and is transmitted to the server 100.

During a game, a favorite team and athletes are recognized based on transmission of a tweet about the game

A team to be supported, athletes and the like are registered in advance

A team supported is recognized according to a position (e.g., seat information in a stadium

It is recognized that a point of excitation is near (e.g., temporally) through heartbeat, sweating, and brain waves.

As described above, according to the first embodiment, invitation conditions of an event are set according to event conditions, so that it is possible to transmit detailed information of the event to a user suitable for participating in the event.

### 3. Second Embodiment

### 3.1. Overview of Second Embodiment

Next, the second embodiment of the present disclosure will be described. In the second embodiment, a community is formed using a continuous pattern of time and a place. For example, it is possible to employ an example in which people having a similar travel route are automatically grouped, and at the time of a travel, people having seen the sights through the same route on the same date are automatically grouped, and communication of the people is facilitated. Consequently, photographs can be shared among a plurality of groups having traveled through the same route, and chat for discussing content such as “What should we do tomorrow?” can be opened and the like.

Consequently, people not previously acquainted with one another can communicate with one another in units of events in a friendly manner. Furthermore, people having travelled together by chance can also be automatically connected to one another, so that communication is possible therebetween.

### 3.2. System Configuration of Second Embodiment

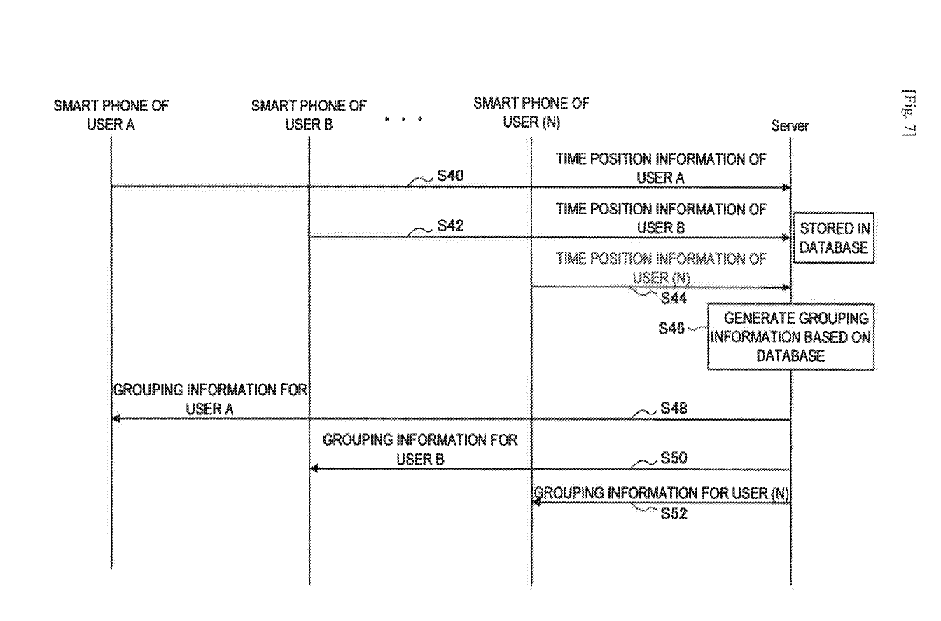

FIG. 6 is a schematic view illustrating the schematic configuration of a system in the second embodiment. As illustrated in FIG. 6, the system of the second embodiment includes a server 200, and user terminals 210 of users A, B, C, (n). For example, the server 200 and the user terminals 210 are connected to each other through 3G/Wifi.

### 3.3. Process of Second Embodiment

FIG. 7 is a sequence diagram illustrating processes of the second embodiment. First, in step S40, the user A transmits time position information from his or her own user terminal 210 to the server 200. Next, in step S42, the user B transmits time position information from his or her own user terminal 210 to the server 200. Next, in step S44, the user (n) transmits time position information from his or her own user terminal 210 to the server 200.

Next, in step S46, the server 200 generates grouping information based on a database. Next, in step S48, the server 200 transmits the grouping information to the user terminal 210 of the user A. Next, in step S50, the server 200 transmits the grouping information to the user terminal 210 of the user B. Next, in step S52, the server 200 transmits the grouping information to the user terminal 210 of the user (n).

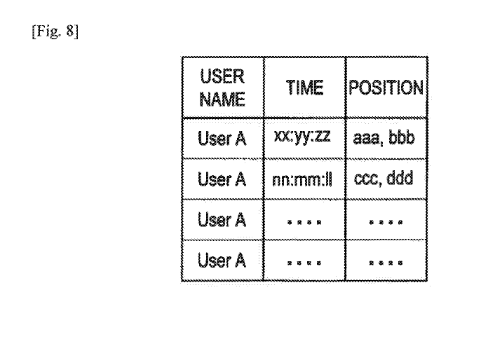

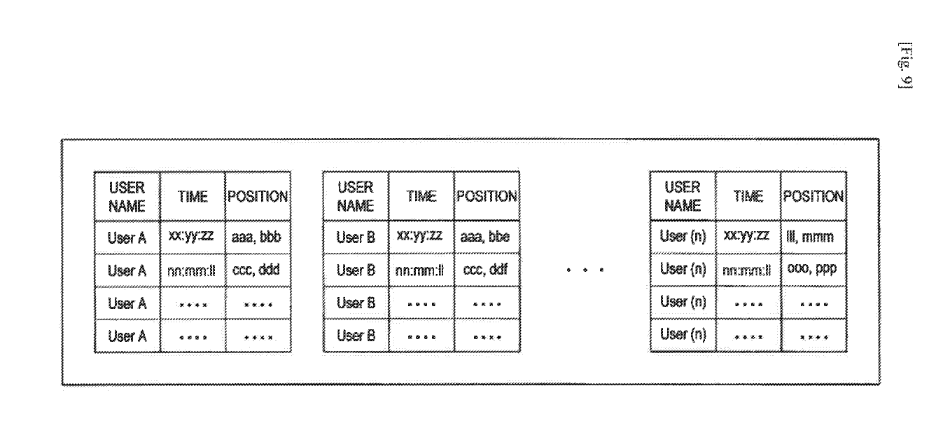

FIG. 8 is a schematic view illustrating an example of time position information (e.g., log) of the user A, which is provided to the server 200, in accordance with embodiments. As illustrated in FIG. 8, the position information of the user A, which changes according to the passage of time, is transmitted to the server 200 together with time information. An example of the uppermost row of the table of FIG. 8 shows the case in which the user A was positioned at latitude aaa and longitude bbb at xx:yy:zz. Although not displayed in FIG. 8, the time information may also include information on year and date in addition to hour, minute, and second.

As illustrated in FIG. 8, logs, which are combinations of at least time and positions, are transmitted from the user terminal 210 to the server 200. The transmission may be performed for one log or a plurality of logs may be collected and transmitted.

The position information is able to be mainly achieved by a GPS of the user terminal 210, and is also to be achieved by 3G, Wifi and the like. Furthermore, the user terminal 210 is able to acquire information on a movement speed, a progress direction, and environment information (e.g., surrounding sound, light and the like), in addition to the time position information, and to transmit the acquired information to the server 200.

User names have been registered in the server 200 in advance. In addition, the user name is not used in essence, and for example, device ID and the like of the user terminal 210 may be used instead thereof. The server 200-side is able to bind the devices with the user names of the user terminals 210.

FIG. 9 is a schematic view illustrating an example of a time position information (e.g., log) database held by the server 200, in accordance with embodiments. As illustrated in FIG. 9, the log information illustrated in FIG. 8 is transmitted to the server 200 for each user.

### 3.4. Process of Generating Grouping Information

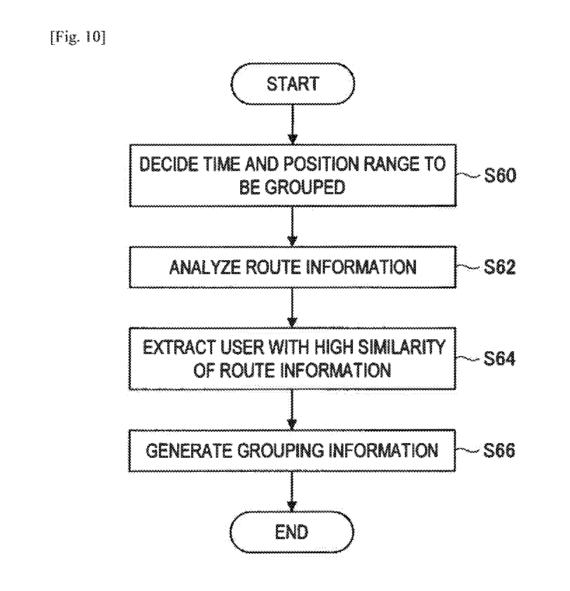

FIG. 10 is a flowchart illustrating a process of generating the grouping information, in accordance with embodiments. First, in step S60, a time range to be grouped is decided. Here, a user side or the server 200 sets a time range of route information to be used for grouping. As the time range to be grouped, for example, “today” (e.g., based on the present time) may be set. In this case, users having traveled through the same route “today” are grouped. In this way, it is possible to set grouping objects from the reference time and the time range.

Grouping time may be individually set as the present or the past. For example, for “today's route” of “his/her own,” based on “today before one year,” persons and the like (e.g., “other users”) having followed the same route within “one month before and after that time” may be grouped. For example, it is possible to recommend a travel to Hawaii or other ocean resorts for a summer vacation this year to a group of persons who travelled to Hawaii last summer.

Furthermore, in step S60, a position range (e.g., a geometrical range) to be grouped is decided. Log data including position information existing in the decided position range is to be grouped. For example, a predetermined latitude and longitude range, a predetermined city, region and the like may be designated as the position range, and the entire world may also be designated as the position range.

In step S62, the route information is analyzed. Furthermore, the route information of a user is analyzed based on information on the set time range. For example, log trace information may be organized. Sightseeing point tour information based on log trace is formed. For example, when tag information exists in a sightseeing point, preference information may also be estimated (e.g., a French restaurant, a world heritage tour, and driving are favorites). Furthermore, residence time may also be considered. For example, when requiring short historic sightseeing and long shopping, the shopping may be estimated to be more favored.

Routes may be classified into a plurality of types of routes according to a place visited, a visiting order, and the like. The route is obscure without considering a detailed position, so that information amount compression and individual information concealment are acquired. Auxiliary information such as a progress direction or a movement speed is used, so that classification with higher accuracy is possible. When a situation is a case in which the progress direction is inverse or the movement speed is too different, there is a difference in a destination or transportation or it may be estimated as a route not matching each preference. Furthermore, grouping is possible by sound. When a plurality of users listen to the same music, it is possible to estimate that the users are driving while playing the music in the same vehicle.

Moreover, grouping is possible by light detected by the user terminal 210. Even in the same place, it is possible to estimate that when a user enters a bright place, it indicates outdoor orientation, and when a user enters a dark place, it indicates indoor preference.

Analysis of the route information may not be necessarily performed in the middle of a flow, and the server 200 may regularly perform the analysis or may perform the analysis at arbitrary time such as a timing at which a user log has been updated.

In step S64, users with high similarity of the route information are extracted. Furthermore, using a result of the analysis, groups of users with similarity of the route information equal to or more than a predetermined threshold value are extracted. Furthermore, groups of users may be extracted from the upper level of the similarity in a predetermined order.

It may be preferable to prepare a plurality of reduced scale levels of a position range of similarity calculation. In detail, it is possible to change a position range including log data to be grouped, according to conditions for extracting user groups. For example, when the number of users extracted as group members from a predetermined position range is much smaller than a predetermined number of persons, a position range (e.g., a geographical range) to be searched is expanded. In contrast, when the number of grouped members is much larger than the predetermined number of persons, a position range can be reduced to extract group members. Users with high similarity are extracted at a city map level, an administrative district level, a country level, and a world level, so that various levels of groups can be generated. People in the same city may discuss where they will go tomorrow, or people having gone to India last year may discuss where they will go this year.

Furthermore, it is possible to extract user groups by combining different time ranges and position ranges with each other. For example, it is possible to use a method for grouping people who have different airplane routes to a travel destination and similar routes in a city. Furthermore, the similarity is converted into points, is ranked, and is tagged, so that the similarity can be easily visualized when grouping information is provided to a user.

Next, in step S66, based on the similarity of the route information, the grouping information is generated. Furthermore, as a result of the user extraction in step S64, information of grouped users is generated.

### 3.5. Configuration Example of Server

FIG. 11 is a block diagram illustrating the configuration of the server 200 that implements the aforementioned processes, in accordance with embodiments. The server 200 includes a time range setting unit 202, a user position information acquisition unit 204, a position range setting unit 205, a movement route analysis unit 206, a grouping unit 208, a message reception unit 210, a message transmission unit 220, and an environment information acquisition unit 222. The time range setting unit 202 decides the time range to be grouped in step S60 of FIG. 10. The time range, for example, may be decided based on information input from the user terminal 210 of a user serving as a host. The user position information acquisition unit 204 acquires route information of a user transmitted from each user terminal 210. The user position information acquisition unit 204 acquires an example of time position information (e.g., log) of a user as illustrated in FIG. 8. The position range setting unit 205 decides a position range of log data to be grouped, according to additional grouping conditions in step S60 of the flow of FIG. 10. The position range, for example, may also be decided based on the information input from the user terminal 210 of the user serving as the host. The movement route analysis unit 206 analyzes the acquired route information in step S62. The grouping unit 208 groups users based on a result of the analysis of the route information in step S64.

Similarly to the first embodiment, each element of the server 200 illustrated in FIG. 11 includes hardware (e.g., a circuit), or a central processing unit such as a CPU and a program (e.g., software) for operating the central processing unit. The program may be stored in a storage unit, such as a memory provided in the server 200, or storage media inserted from an exterior, and may be downloaded to the server 200 through a network such as the Internet.

In the second embodiment, the configuration of the user terminal 210 is similar to that of the user terminal 120 of the first embodiment illustrated in FIG. 5.

### 3.6. Example of Grouping Information

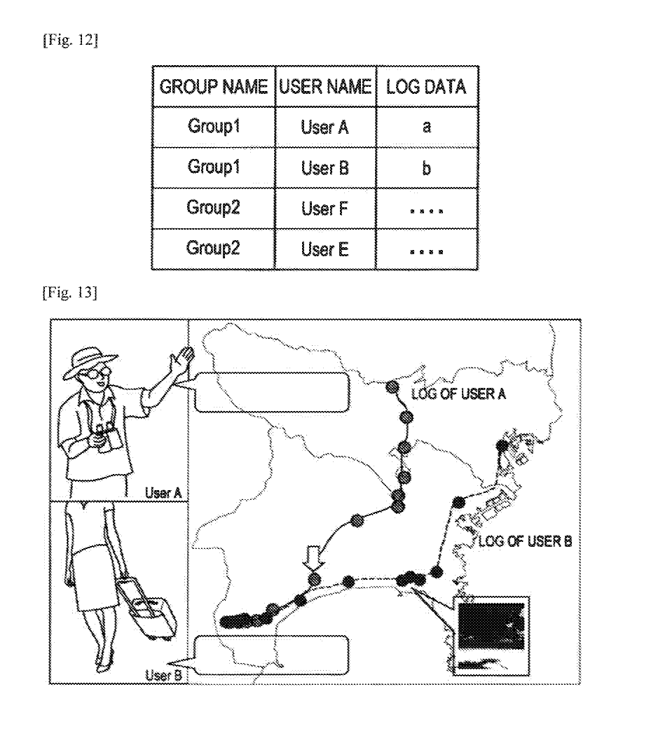

FIG. 12 is a schematic view illustrating an example of the grouping information, in accordance with embodiments. As illustrated in FIG. 12, a list of user names is provided minimally. Since log data is individual data, only data of an approved user is transmitted. In the example illustrated in FIG. 12, as a result of group extraction, a user A and a user B belong to group 1 and a user F and a user E belong to group 2.

FIG. 13 is a schematic view illustrating an example of screen display based on the grouping information, in accordance with embodiments. In FIG. 13, routes of a plurality of users are indicated by dots and users with similar routes in a time range are grouped. When users belonging to the same group and having very high similarity of routes can be estimated as traveling companions and grouped, a message for checking “friends?” or not can be exchanged between the user terminals 210, and when it is possible to check that they are friends, photographs can be shared. Even when they are not friends and a user providing photographs has approved, the photographs can be shared. Furthermore, users belonging to the same group can also discuss a place to be visited tomorrow on a map while chatting. Furthermore, it is also possible to check a sightseeing place recommended to a person who traveled through a similar route in the past.

The server 200 stores as an event units of information on a route visited once. When a home position of a user has been registered and the user has visited a place apart from his/her own home by a constant distance or more, a period until the user returns his/her home is estimated as “travel.” The event is preserved so that it is possible to access groups of each event in the past. It is also possible to exchange a message including an intention to travel again with a person with whom he or she traveled at that time. It is possible to propose a new event for a past group from past grouping information. Information of a new sightseeing point may be transmitted to a group at possible timing.

### 3.7. For Classification of Route Information Analysis

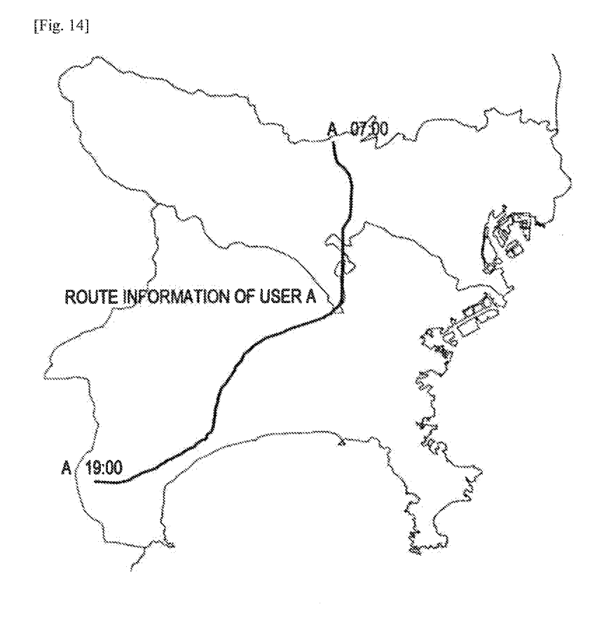

Next, an example of classification of the route information analysis will be described. FIG. 14 is a schematic view illustrating a route of the user A, in accordance with embodiments. Furthermore, the classification of route information of the user A is considered and 07:00 to 19:00 on a specific date is set as a time range. The position information of the user terminal 210 is sequentially transmitted from the user terminal 210 to the server 200, and is acquired by the server 200.

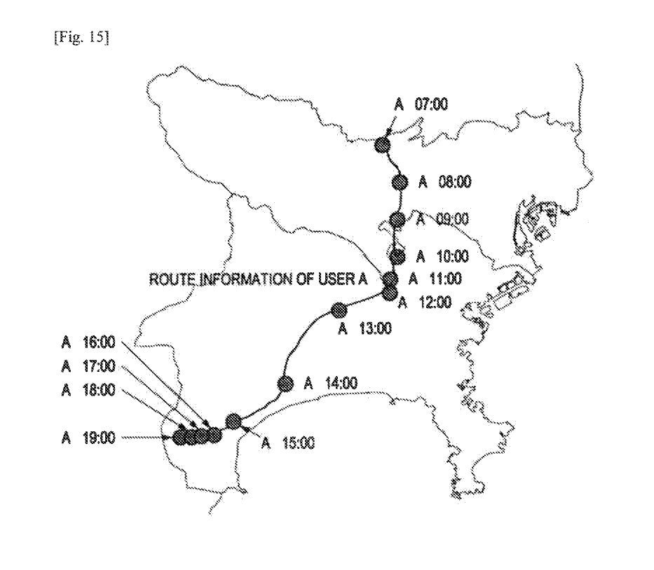

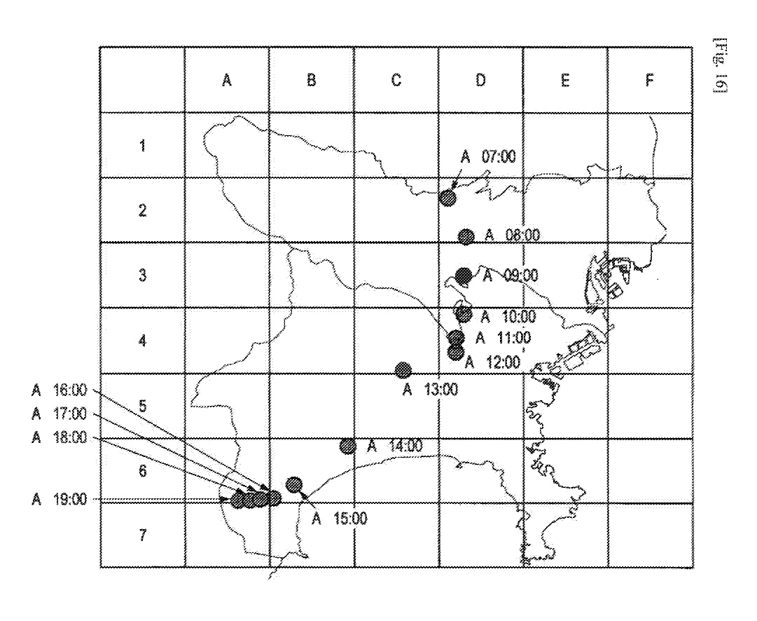

As illustrated in FIG. 15, detailed time information of the user A is thinned into spot data at a constant interval from the information on the route illustrated in FIG. 14. In this example, data thinning is performed such that data for every hour remains.

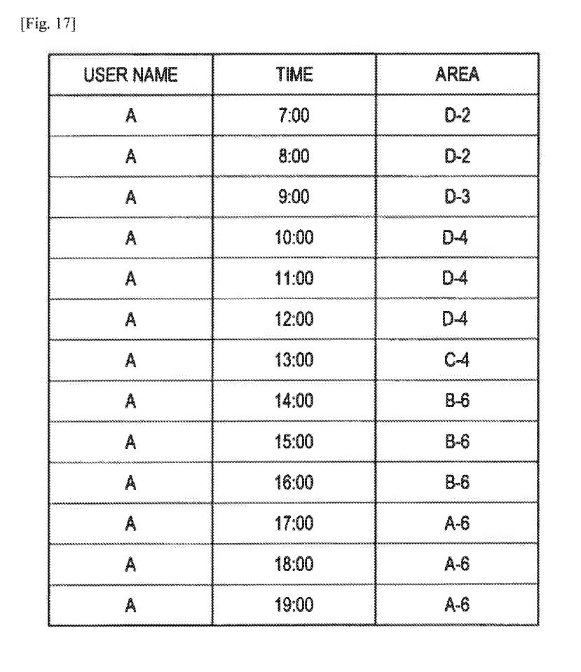

Next, as illustrated in FIG. 16, a position is divided into predetermined ranges and data of time and an area in which a user has stayed is generated, in accordance with embodiments. This example shows a case in which the user A stayed in area D-2 at 07:00. Then, when all data of FIG. 16 is processed, data as illustrated in FIG. 17 can be acquired.

As data for classifying a user position, data illustrated in FIG. 17 can be used, in accordance with embodiments. Furthermore, as another aspect, classified data can be specified according to the passage of a specific area. For example, when a service area of a highway exists in area C-4 and area A-6 is a sightseeing place α, the user A can be largely classified by assuming that “the user A is a person who took the highway to the sightseeing place α (e.g., by vehicle).” When the user A is largely classified as described above, the type thereof may be used as tag information. In this case, in order to narrow a specific point, it is preferable to set a region determined as the specific point by area division in more detail.

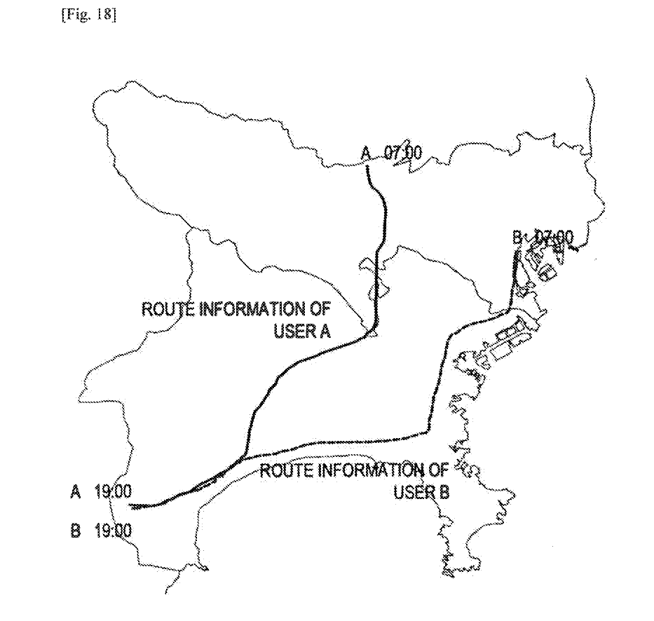

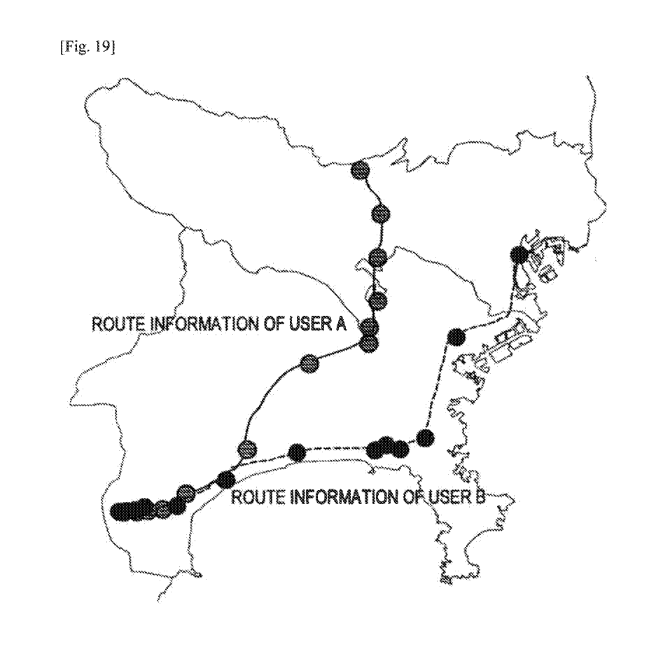

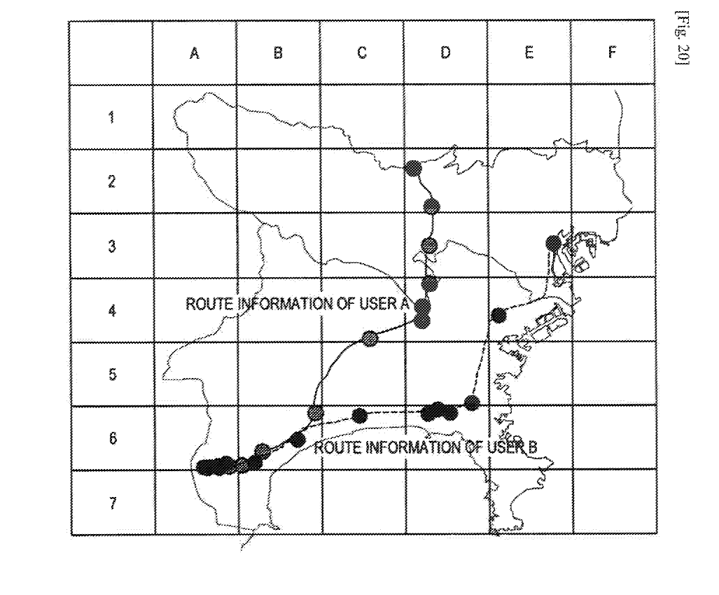

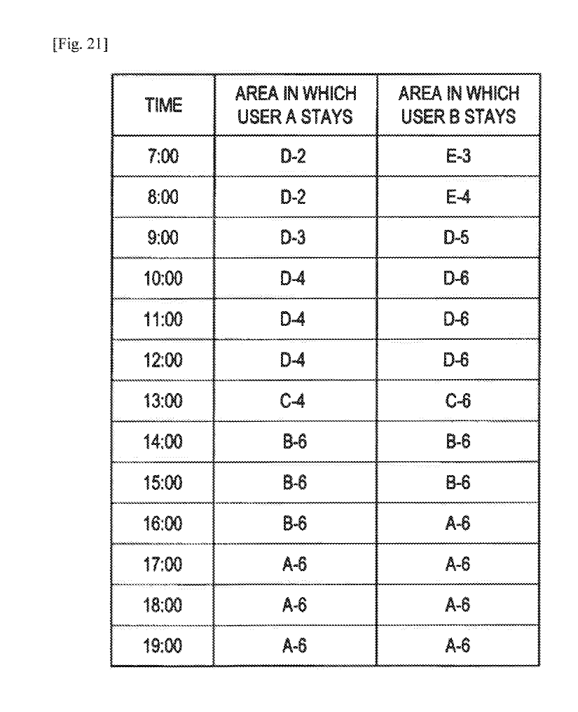

Hereinafter, a calculation example of similarity of the route information of the users A and B will be described. FIG. 18 illustrates the route information of the user B together with the route information of the user A, and illustrates the case in which 07:00 to 19:00 on a specific date is a time range, in accordance with embodiments. FIG. 19 illustrates the state in which the route information of the user B has been thinned out, similarly to FIG. 15, and in accordance with embodiments. Furthermore, FIG. 20 and FIG. 21 illustrate the state in which the positions of the users A and B have been divided into predetermined ranges and data of time and areas in which the users A and B have stayed has been generated, similarly to FIG. 16 and FIG. 17, and in accordance with embodiments.

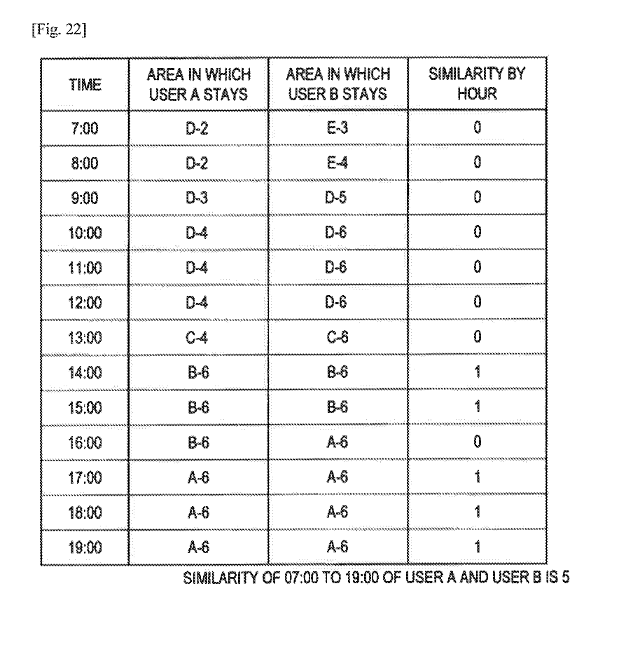

FIG. 22 is a schematic view illustrating an example in which similarity has been calculated, in accordance with embodiments. Basically, when the users A and B stay in the same place at the same time, the similarity is high. In the example of FIG. 18, when the users A and B stay in the same place at the same time, 1 is added to the similarity. The total amount of the similarity of each hour is set as final similarity of the users A and B. In this case, the similarity of 07:00 to 19:00 of the user A and the user B is “1+1+1+1+1=5.”

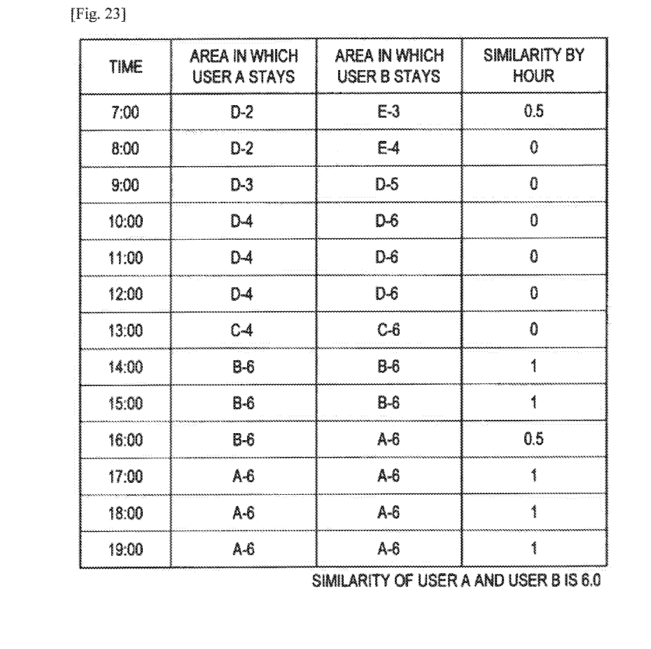

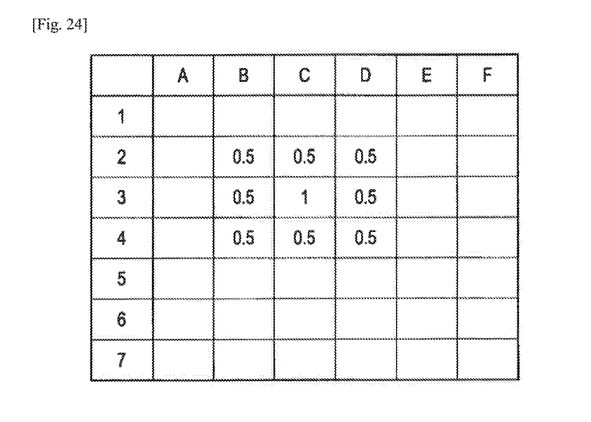

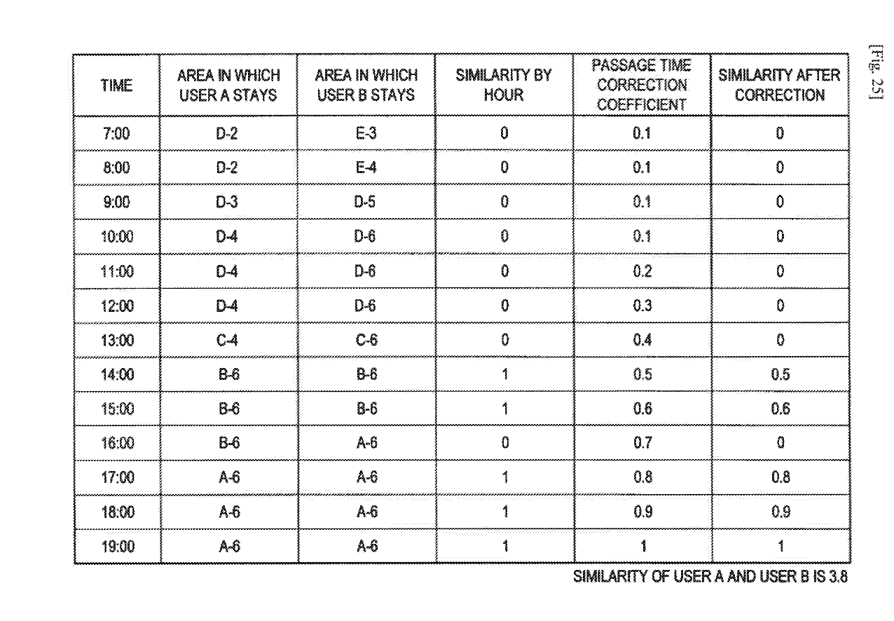

FIG. 23 and FIG. 24 are schematic views illustrating an example using similarity by hour according to the degree of proximity of areas, in addition to determination regarding whether the areas are equal to each other, in accordance with embodiments. For example, as illustrated in FIG. 24, for 8 areas adjacent to a specific area (area C-3 in FIG. 24), the similarity may for each hour be set to 0.5. When this technique is applied to the example of FIG. 22, the similarity of 07:00 and the similarity of 16:00 are each “0.5” as illustrated in FIG. 23. Consequently, the similarity of 07:00 to 19:00 of the user A and the user B is set to “0.5+1+1+0.5+1+1+1=6” and is higher than that of FIG. 22, so that it is possible to determine the similarity in more detail. In the same manner, for adjacent times (e.g., one hour before and after), a correction coefficient according to the degree of proximity of time may be used.

Furthermore, in another example, as illustrated in FIG. 25, a correction coefficient according to the passage of time may be multiplied, in accordance with embodiments. As the time approaches the present time (it is assumed that the present time is 19:00), the similarity is high. By the time for which a user stays near a travel destination, since it is valid for similarity calculation, it is possible to find a user who stays in a place near a present destination.

In further another example, a destination may be estimated from log data up to now and the similarity may be calculated. For example, it may be possible to employ a technique for estimating the similarity of 19:00 from among data for 7:00 to 14:00 or estimating a destination from the total amount of past data of other users. The movement route analysis unit 206 of the server 200 performs the aforementioned processes of FIG. 15 to FIG. 25, in accordance with embodiments.

The grouping unit 208 of the server 200 sets groups based on the similarity. In this case, when a threshold value is provided to the total amount of the similarity of 07:00 to 19:00 and the total amount of the similarity exceeds the threshold value, the user A and the user B may be assumed to belong to the same group.

As described above, according to the second embodiment, it is possible acquire position information of users in a time range and to group users who have similar routes in the time range. Consequently, it is possible to exchange information among the grouped users.

### 4. Third Embodiment

### 4.1. Overview of Third Embodiment

Next, the third embodiment of the present disclosure will be described. In the third embodiment, users in the same environment at the present time are grouped. Consequently, it is possible to transmit information to the grouped users and collect information from users in the same group.

Furthermore, the same environment includes the case in which a position and activity are similar, the case in which users get on the same train, the case in which users are involved in the same traffic jam, and the like. Automatic grouping of users is performed based on position and activity information of each user. The information to be transmitted includes message delivery among users, message delivery from a server to users in a group, the present degree of congestion of each vehicle, estimation of the degree of congestion, congestion information and the like.

The configuration of a system of the third embodiment is similar to that of the second embodiment illustrated in FIG. 6, and includes a server 300 and a user terminal 400. The position and activity information is transmitted from the user terminals 400 of the users A, B, C, . . . (n) to the server 300. The server 300 groups users based on the position and activity information.

### 4.2. Process of Third Embodiment

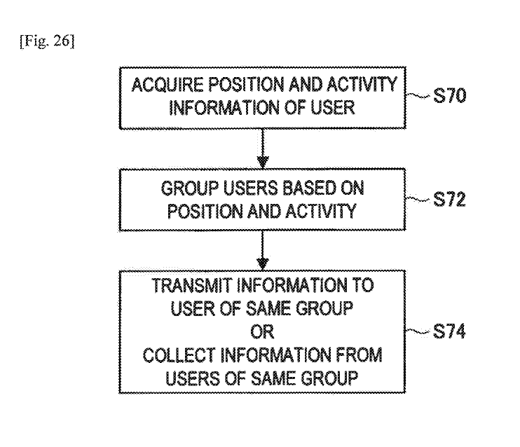

FIG. 26 is a flowchart illustrating processes of the third embodiment. First, in step S70, position and activity information of users is acquired.

In step S72, the users are grouped based on the position and activity information of the users. Furthermore, the users are grouped based on the activity types, positions, movement speeds, movement directions and the like of the users. The movement speed and movement direction may be calculated by one of the user terminals 400 and the server 300.

In relation to a grouping unit, for example, users getting on the same train are grouped. In this case, users who have the activity type of a train, are positioned in a relatively predetermined range, move at approximately the same movement speed (e.g., a relative speed is approximately zero), and move in a direction in a relatively predetermined range are grouped.

Furthermore, it is possible to group users getting on the same bus or vehicle. In this case, users who have the activity type of a bus or a vehicle, are positioned in a relatively predetermined range, move at approximately the same movement speed (e.g., a relative speed is approximately zero), and move in a direction in a relatively predetermined range are grouped.

Furthermore, it is possible to group users involved in the same traffic jam. In this case, users who have the activity type of a bus or a vehicle, are positioned in a relatively predetermined range, move at a movement speed equal to or less than a predetermined speed, and move in a direction in a relatively predetermined range are grouped.

Next, in step S74, information is transmitted to the users of the same group who have been grouped in step S72. Furthermore, in step S74, information is collected from the users of the same group who have been grouped in step S72.

### 4.3. Configuration Example of Server

FIG. 27 is a block diagram illustrating the configuration of the server 300 that implements the aforementioned processes, in accordance with embodiments. The server 300 includes a position and activity information acquisition unit 302 for acquiring position and activity information of a user, a grouping unit 304, a movement speed acquisition unit 306, an information transmission unit 308, an activity type acquisition unit 310, a message reception unit 312, a message transmission unit 314, an ID transmission unit 316, a message collecting unit 318, a control information transmission unit 320, a congestion degree calculation unit 322, a user state acquisition unit 324, and a vacancy rate calculation unit 326. The position and activity information acquisition unit 302 acquires the position and activity information of users in step S70 of FIG. 23. The grouping unit 304 groups the users based on the activity types, positions, movement speeds, movement directions and the like of the uses in step S72. The information transmission unit 308 transmits information to the grouped users of the same group in step S74.

Furthermore, the movement speed acquisition unit 306 acquires the movement speed of the user terminal 400. The movement speed can be calculated from the position information of a user and time. The activity type acquisition unit 310 acquires the activity type of a user. The activity type includes the type of transportation (e.g., a train, a bus, an automobile (a car) and the like) used by a user holding the user terminal 400. Furthermore, the activity type acquisition unit 310 acquires activity of a user recognized by an activity recognition unit 418 of the user terminal 400. The message reception unit 312 receives a message from the user terminal 400. Furthermore, the message transmission unit 314 transmits a message to the user terminal 400. Specifically, the message transmission unit 314 transmits a message to a user terminal 400 which belongs to the same group as the user terminal 400 having received the message. The ID transmission unit 316 transmits a group ID or an ID of a user terminal belonging to a group to a plurality of grouped user terminals.

Furthermore, the message collecting unit 318 collects messages transmitted from a plurality of grouped user terminals 400. The control information transmission unit 320 transmits control information to transportation, a building and like, in which the plurality of grouped user terminals are positioned, based on the messages collected by the message collecting unit 318. The congestion degree calculation unit 322 calculates the congestion degree based on a region area corresponding to the plurality of grouped user terminals 400, and the number of grouped user terminals 400. The user state acquisition unit 324 acquires user states indicating whether users using the grouped user terminals 400 are standing or sitting in a vehicle of transportation. The vacancy rate calculation unit 326 calculates a vacancy rate based on the number of grouped user terminals 400 and the user states.

### 4.4. Configuration Example of User Terminal

FIG. 28 is a schematic view illustrating the configuration of the user terminal 400, in accordance with embodiments. As illustrated in FIG. 28, the user terminal 400 includes a communication unit 402, a display unit 404, a control unit 406, an input unit 408, a sensor data creation unit 410, and an activity recognition unit 418.

The sensor data creation unit 410 senses user activity and creates sensor data which is information corresponding to activity of a corresponding user. In addition, the user activity described herein indicates information regarding whether a user is walking, running, standing, sitting, jumping, stationary; boarding a train, boarding an elevator, turning right, turning left, and the like. The information on the user activity, for example, indicates activity of a user accompanied with the user terminal 400. The sensor data is based on activity performed by the user having the user terminal 400.

The activity recognition unit 418 acquires the sensor data from the sensor data creation unit 410. The activity recognition unit 418 performs a predetermined threshold process for the sensor data to recognize activity performed by a user, and generates activity information indicating the activity performed by the user. The activity recognition unit 418 further includes a plurality of activity determination sections specialized for the activity performed by the user, and generates the activity information based on results of the determination in the plurality of activity determination sections. In addition, the sensor data, for example, includes acceleration sensor data and gyro sensor data.

Moreover, the acceleration sensor data may include first acceleration sensor data, second acceleration sensor data, and third acceleration sensor data. The first acceleration sensor data relates to acceleration along a predetermined coordinate axis. Furthermore, the second acceleration sensor data relates to acceleration along a coordinate axis different from the coordinate axis of the first acceleration sensor data, and for example, the coordinate axis is perpendicular to the coordinate axis of the first acceleration sensor data. Furthermore, the third acceleration sensor data relates to acceleration along a coordinate axis different from the coordinate axes of the first acceleration sensor data and the second acceleration sensor data, and for example, the coordinate axis is perpendicular to the coordinate axes of the first acceleration sensor data and the second acceleration sensor data.

Each of the plurality of activity determination sections may include a stationary state determination part 422, a walking and running state determination part 424, a jumping state determination part 426, a posture change determination part 428, an elevator hoarding determination part 430, a train boarding determination part 432, and a right turning and left turning determination part 434.

The stationary state determination part 422 determines whether a user is in a stationary state. The walking and running state determination part 424 determines whether a user is in a walking state or a running state. The jumping state determination part 426 determines whether a user is in a jumping state. The posture change determination part 428 determines whether a user is in a standing state or a sitting state. The elevator boarding determination part 430 determines whether a user is in an elevator boarding state. The train boarding determination part 432 determines whether a user is in a train boarding state. The right turning and left turning determination part 434 determines whether a user turns right or turns left. As described above, according to the user terminal 400 in accordance with the present embodiment, it is possible to understand each activity with high accuracy using an activity recognition function specialized in each activity.

### 4.5. Message Delivery Technique to Grouped User

Next, message delivery technique to grouped users will be described. First, the message delivery technique to the grouped users includes message delivery through the server 300. In this case, the server 300 delivers a message acquired from the user terminal 400. Messages of users in a group can be received in the server 300 and can be delivered to other user terminals 400 in the same group through the server.

Furthermore, another delivery technique includes message delivery based on ad-hoc (Adhoc) communication. In this case, when users have been grouped, a group ID or a list of users belonging to the same group is transmitted from the server 300 to the user terminal 400. Furthermore, a user may transmit a message through direct ad-hoc (Adhoc), deliver a message to a small number of persons in a group from the server 300, and a message from the server 300 may be delivered to surrounding users (Adhoc) through the small number of persons.

According to a method for collecting information from users in the same group, messages from the users in the same group are collected in the server 300. Based on user IDs assigned to messages transferred from the user terminals 400, or group IDs, the server 300 collects the messages in units of groups. Messages may be delivered from the server 300 to only users in a group, or only replies of the messages may be collected in the server 300. A specific ID may be assigned to the reply, or a return address may be specified in each group.

### 4.6. Use Example of Third Embodiment

Hereinafter, a use example of the third embodiment will be described. First, as the use example, it is possible to exchange a message of congestion information. Among users in a group involved in the same congestion, a user group positioned in the head is designated (including automatic designation) and the server 300 transmits a message, so that it is possible to perform an inquiry about the cause of congestion with a pinpoint. Consequently, the server 300 is able to acquire the cause of the congestion, so that it is possible to transmit information on the cause of the congestion to other users in a group. In this case, since it is possible to determine the head of the group based on a progress direction of a user in the group, it is sufficient if a user group positioned in a predetermined range from the head position is designated.

Furthermore, it is possible to perform air conditioning control in a vehicle and in a room. In this case, the server 300 receives and collects messages indicating “hot,” “cold” and the like. Consequently, it is possible to control air conditioning in a room or in a vehicle according to the collecting.

Furthermore, it is possible to estimate the present congestion degree and provide a user with the estimated congestion degree. Population density is calculated based on a region area corresponding to a position corresponding to a grouped user group and the number of people in a group, and is transmitted to users in or out of the group as congestion degree. Moreover, a user group in the same group is divided into a predetermined number (e.g., the number of vehicles) of subgroups based on relative positions of users in the same group and congestion degree is estimated in units of subgroups, so that it is possible to estimate a degree of congestion of each vehicle. Furthermore, when determination of “sitting” in the activity type is possible, it is also possible to estimate a vacancy rate based on “the number of users who are sitting” and “the number of seats associated with a region corresponding to a group or sub-group,”

Furthermore, it is possible to estimate a future degree of congestion and provide a user with the estimated degree of congestion. When a user log (e.g., activity history, history information on a traffic IC card and the like) is able to be acquired, it is possible to estimate a disembarkation station of each user based on the log, so that it is possible to estimate congestion degree after predetermined time lapses or at the time of arrival at a predetermined station.

Furthermore, it is possible to display the degree of congestion on the user terminal 400. In this case, the congestion degree may be displayed with a numerical value based on population density of each group or each subgroup, or the population density may be divided into a plurality of levels and then the congestion degree may be expressed in units of levels. Moreover, the congestion degree may be displayed using a color associated with an obtained numerical value or level, or a distribution map.

As described above, according to the third embodiment, it is possible to group users in the same environment based on the position information acquired from the user terminal 400. Consequently, it is possible to exchange a message related to the environment among the users in the same environment. Furthermore, it is also possible to collect messages from the users in the same environment and to optimally control environment conditions.

It should be understood by those skilled in the art that various modifications, combinations, sub-combinations and alterations may occur depending on design requirements and other factors insofar as they are within the scope of the appended claims or the equivalents thereof.

Additionally, the present technology may also be configured as below.

(1) An information processing apparatus including:
an acquisition unit configured to acquire information from a plurality of terminal nodes;
an analysis unit configured to analyze the acquired information and generate route information for each individual one of the plurality of terminal nodes; and
a grouping unit configured to group the plurality of terminal nodes based on the route information.
(2) The information processing apparatus of (1), wherein the grouping unit is further configured to group the plurality of terminal nodes based on a similarity of the route information between respective ones of the plurality of terminal nodes.
(3) The information processing apparatus of (1), wherein the grouping unit is further configured to group the plurality of terminal nodes based on a degree of proximity areas representing a similarity of route information between respective ones of the plurality of terminal nodes.
(4) The information processing apparatus (1), wherein the acquired information includes sets of discrete time points and corresponding position information indicating positions of the terminal nodes at the discrete time points.
(5) The information processing apparatus of (4), wherein the acquired information further includes at least one of a sound detected information and an amount of light detected information.
(6) The information processing apparatus of (4), wherein the corresponding position information includes vector direction of travel information of the plurality of terminal nodes at the discrete time points.
(7) The information processing apparatus of (1), wherein the acquired information includes sets of discrete time points and corresponding position information indicating area zones within which the terminal nodes are located at the discrete time points.
(8) The information processing apparatus of (7), wherein the area zones are adjacent geographic regions.
(9) The information processing apparatus of (1), wherein the acquired information includes time and corresponding position information, speed information, direction of travel information, and environment information.
(10) The information processing apparatus of (1), wherein the acquired information includes positional log data.
(11) The information processing apparatus of (1), wherein the acquired information includes a time range data and a position range data.
(12) The information processing apparatus of (1), wherein the route information is classified as one or more classification types based on at least one of a place visited, a visiting order, a progress direction, a movement speed, and an environment sound.
(13) The information processing apparatus of (11), wherein the grouping unit groups the plurality of terminal nodes based on a commonality of the time range data or a commonality of the position range data between the plurality of terminal nodes.
(14) The information processing apparatus of (1), wherein the acquired information includes user preference information pertaining to locations along routes of travel of the plurality of terminal nodes.
(15) The information processing apparatus of (1), further including:
a communication unit configured to allow communications between terminal nodes of the plurality of terminal nodes that are grouped within a common group.
(16) The information processing apparatus of (15), wherein the communication unit notifies each terminal node of the terminal nodes that are grouped within the common group of a recommended event or location for travel, based on the information acquired from the terminal nodes that are grouped within the common group.
(17) The information processing apparatus of (15), wherein the communication unit notifies each terminal node of the terminal nodes that are grouped within the common group of a recommended future event or future travel route, based on the information acquired from the terminal nodes that are grouped within the common group.
(18) The information processing apparatus of (15), wherein the communication unit facilitates communications between terminal nodes that are grouped within the common group to allow transfer of at least one of an image data and a message data between the terminal nodes within the common group.
(19) The information processing apparatus of (3), wherein the degree of proximity areas is determined to be larger between respective ones of the plurality of terminal nodes when the respective ones of the plurality of terminal nodes are located within same proximate areas at common times.
(20) The information processing apparatus of (8), wherein the area zones define geographic boundaries partitioning at least a portion of a geographic region.
(21) The information processing apparatus of (20), wherein the area zones are rectangular geographic boundaries.
(22) The information processing apparatus of (1), wherein the position information is sampled at discrete time intervals.
(23) The information processing apparatus of (13), wherein the position range data includes vector direction of travel information.
(24) The information processing apparatus of (15), wherein the communication unit notifies each terminal node of the terminal nodes that area grouped within the common group of an existence of other terminal nodes of the terminal nodes that are grouped within the common group.
(25) An information processing method including:
acquiring information from a plurality of terminal nodes;
analyzing the acquired information and generating route information for each individual one of the plurality of terminal nodes; and
grouping the plurality of terminal nodes based on the route information.
(26) A non-transitory computer-readable medium embodied with a program, which when executed by a computer, causes the computer to perform a method including: acquiring information from a plurality of terminal nodes;
analyzing the acquired information and generating route information for each individual one of the plurality of terminal nodes; and
grouping the plurality of terminal nodes based on the route information.
(27) An information processing apparatus including:
a reception unit that receives condition information of an event from a user terminal of a host;
an invitation condition setting unit that sets an invitation condition for deciding a user able to be invited to the event based on the condition information; and
a transmission unit that transmits information on the event to a terminal of a user based on the invitation condition.
(28) The information processing apparatus according to (27), wherein the invitation condition setting unit calculates a score of a user based on a present position of the user, avenue of an event, and a time at which the event is to be held, and sets an invitation condition of the user based on the score.
(29) The information processing apparatus according to (27), wherein the invitation condition setting unit calculates a score of a user based on preference information of the user and a type of an event, and sets an invitation condition of the user based on the score.
(30) The information processing apparatus according to (27), wherein the invitation condition setting unit calculates a score of a user based on profile information of the user, and sets an invitation condition of the user based on the score.
(31) The information processing apparatus according to (27), wherein the invitation condition setting unit calculates a score of a user based on a past event participation history of the user, and sets an invitation condition of the user based on the score.
(32) The information processing apparatus according to any one of (28) to (30), wherein the invitation condition setting unit sets a user having the score equal to or more than a predetermined value as a participation candidate, and the transmission unit transmits information on an event to the user who is the participation candidate.
(33) The information processing apparatus according to (28), wherein, when, based on a present position of a user, a venue of an event, and a time at which the event is to be held, the user is not predicted to reach the venue of the event at the time, the invitation condition setting unit does not set the user as a participation candidate.
(34) The information processing apparatus according to (27), further including:
a menu information transmission unit that transmits, to the user terminal, menu information used to allow a user to input the condition information of the event on the user terminal.
(35) The information processing apparatus according to (34), wherein the menu information is used to allow a user to input a type of an event, a venue of the event, a start time of the event, an end time of the event, an age of a participant, a sex of the participant, a present position of the user, a future schedule of the user, or preference information of the user.
(36) The information processing apparatus according to (27), further including:
a reception unit that receives a response from a user terminal to which the transmission unit has transmitted information on an event; and
a determination unit that determines whether the user satisfies condition information of the event based on the response.
(37) An information processing method including:
receiving condition information of an event from a user terminal of a host;
setting an invitation condition for deciding a user able to be invited to the event based on the condition information; and
transmitting information on the event to a terminal of a user based on the invitation condition.
(38) A program for causing a computer to execute functions of:
receiving condition information of an event from a user terminal of a host;
setting an invitation condition for deciding a user able to be invited to the event based on the condition information; and
transmitting information on the event to a terminal of a user based on the invitation condition.
(39) An information processing system including:
a user terminal that transmits condition information of an event; and
an information processing apparatus including a reception unit that receives the condition information of the event from a user terminal of a host, an invitation condition setting unit that sets an invitation condition for deciding a user able to be invited to the event based on the condition information, and a transmission unit that transmits information on the event to a terminal of a user based on the invitation condition.
(40) An information processing apparatus including:
a time range setting unit that sets a time range for grouping a plurality of users based on routes;
a position information acquisition unit that acquires position information of user terminals in the time range;
a movement route analysis unit that analyzes movement routes of the user terminals based on the position information; and
a grouping unit that groups the plurality of users based on the analysis result of the movement routes.
(41) The information processing apparatus according to (40), wherein the movement route analysis unit calculates similarity of the movement routes of the user terminals based on positions for each hour of the user terminals, and the grouping unit performs grouping based on the similarity.
(42) The information processing apparatus according to (40), further including:
a position range setting unit that sets a position range for grouping a plurality of users based on routes,
wherein the position range setting unit acquires position information of user terminals based on the position range.
(43) The information processing apparatus according to (40), further including:
a message reception unit that receives messages, which are transmitted to other user terminals in the same group, from the grouped user terminals; and
a message transmission unit that transmits the messages to the other user terminals.
(44) The information processing apparatus according to (40), wherein the movement route analysis unit analyzes the movement routes by considering movement speeds of the user terminals, in addition to the position information.
(45) The information processing apparatus according to (40), further including:
an environment information acquisition unit that acquires environment information including sound or light from the user terminals,
wherein the route analysis unit analyzes the movement routes by considering the environment information in addition to the position information.
(46) The information processing apparatus according to (40), wherein, when the analysis result of the movement route of one user terminal is similar to a past analysis result of the movement route of another user terminal, the grouping unit causes the one user terminal and the other user terminal to belong to the same group.
(47) An information processing method including:
setting a time range for grouping a plurality of users based on routes;
acquiring position information of user terminals in the time range;
analyzing movement routes of the user terminals based on the position information; and
grouping the plurality of users based on the analysis result of the movement routes.
(48) A program for causing a computer to execute functions of:
setting a time range for grouping a plurality of users based on routes;
acquiring position information of user terminals in the time range;
analyzing movement routes of the user terminals based on the position information; and
grouping the plurality of users based on the analysis result of the movement routes,
(49) An information processing system including:
a plurality of user terminals that acquire position information; and
an information processing apparatus including a time range setting unit that sets a time range for grouping a plurality of users based on routes, a position information acquisition unit that acquires position information of user terminals in the time range, a movement route analysis unit that analyzes movement routes of the user terminals based on the position information, and a grouping unit that groups the plurality of users based on the analysis result of the movement routes.
(50) An information processing apparatus including:
a position information acquisition unit that acquires position information from a plurality of user terminals; and
a grouping unit that groups user terminals in the same environment based on the position information.
(51) The information processing apparatus according to (50), further including:
a movement speed acquisition unit that acquires movement speeds of the user terminals,
wherein the grouping unit performs the grouping based on the position information and the movement speeds.
(52) The information processing apparatus according to (50), further including:
an information transmission unit that transmits information unique to a group to grouped user terminals.
(53) The information processing apparatus according to (50), further including:
an activity type acquisition unit that acquires activity types of a plurality of user terminals,
wherein the grouping unit determines whether the user terminals are in the same environment based on the position information and the activity types.
(54) The information processing apparatus according to (53), wherein the activity type is a type of transportation used by users holding the user terminals.
(55) The information processing apparatus according to (54), wherein the grouping unit groups a plurality of user terminals that are positioned in a train of a transportation agency, are positioned in a relatively predetermined range, and move in a relatively predetermined range at the same speed as a group of users using a train.
(56) The information processing apparatus according to (54), wherein the grouping unit groups a plurality of user terminals that are positioned in a bus of a transportation agency, are positioned in a relatively predetermined range, and move in a relatively predetermined range at the same speed as a group of users using a bus.
(57) The information processing apparatus according to (54), wherein the grouping unit groups a plurality of user terminals that are positioned in a bus or a train of a transportation agency, are positioned in a relatively predetermined range, have a movement speed equal to or less than a predetermined value, and move in relatively the same direction as a group of users involved in congestion.
(58) The information processing apparatus according to (50), further including:
a message reception unit that receives messages, which are transmitted to other user terminals belonging to the same group, from the grouped user terminals; and
a message transmission unit that transmits the messages to the other user terminals.
(59) The information processing apparatus according to (50), further including:
an ID transmission unit that transmits a group ID or an ID of a user terminal belonging to a group to the plurality of user terminals in order to allow the plurality of grouped user terminals to directly communicate with one another.
(60) The information processing apparatus according to (50), further including:
a message collecting unit that collects messages transmitted from the plurality of grouped user terminals.
(61) The information processing apparatus according to (60), further including:
a control information transmission unit that transmits control information to a transportation agency, a building and the like, in which the plurality of grouped user terminals are positioned, based on the collected messages.
(62) The information processing apparatus according to (52), further including:
a congestion degree calculation unit that calculates a degree of congestion based on a region area corresponding to the plurality of grouped user terminals, and the number of the plurality of grouped user terminals, wherein the congestion degree is transmitted as unique information.
(63) The information processing apparatus according to (52), further including:
a user state acquisition unit that acquires user states indicating whether users using the grouped user terminals are standing or sitting in a vehicle of the transportation agency; and
a vacancy rate calculation unit that calculates a vacancy rate based on the number of the plurality of grouped user terminals and the user states.
(64) An information processing method including:
acquiring position information from a plurality of user terminals; and
grouping user terminals in the same environment based on the position information.
(65) A program for causing a computer to execute functions of:
acquiring position information from a plurality of user terminals; and
grouping user terminals in the same environment based on the position information.
(66) An information processing apparatus including:
a plurality of user terminals that acquire position information;
a position information acquisition unit that acquires the position information from the plurality of user terminals; and
a grouping unit that groups user terminals in the same environment based on the position information.

The present disclosure contains subject matter related to that disclosed in Japanese Priority Patent Application JP 2012-143952 filed in the Japan Patent Office on Jun. 27, 2012, the entire content of which is hereby incorporated by reference.

### REFERENCE SIGNS LIST

100 Server
102b Reception unit
106 Invitation condition setting unit
104b Transmission unit

1. An information processing apparatus comprising:
an acquisition unit configured to acquire information from a plurality of terminal nodes;
an analysis unit configured to analyze the acquired information and generate route information for each individual one of the plurality of terminal nodes; and
a grouping unit configured to group the plurality of terminal nodes based on the route information.

2. The information processing apparatus of claim 1, wherein the grouping unit is further configured to group the plurality of terminal nodes based on a similarity of the route information between respective ones of the plurality of terminal nodes.

3. The information processing apparatus of claim 1, wherein the grouping unit is further configured to group the plurality of terminal nodes based on a degree of proximity areas representing a similarity of route information between respective ones of the plurality of terminal nodes.

4. The information processing apparatus of claim 1, wherein the acquired information comprises sets of discrete time points and corresponding position information indicating positions of the terminal nodes at the discrete time points.

5. The information processing apparatus of claim 4, wherein the acquired information further comprises at least one of a sound detected information and an amount of light detected information.

6. The information processing apparatus of claim 4, wherein the corresponding position information comprises vector direction of travel information of the plurality of terminal nodes at the discrete time points.

7. The information processing apparatus of claim 1, wherein the acquired information comprises sets of discrete time points and corresponding position information indicating area zones within which the terminal nodes are located at the discrete time points.

8. The information processing apparatus of claim 7, wherein the area zones are adjacent geographic regions.

9. The information processing apparatus of claim 1, wherein the acquired information comprises time and corresponding position information, speed information, direction of travel information, and environment information.

10. The information processing apparatus of claim 1, wherein the acquired information comprises positional log data.

11. The information processing apparatus of claim 1, wherein the acquired information comprises a time range data and a position range data.

12. The information processing apparatus of claim 1, wherein the route information is classified as one or more classification types based on at least one of a place visited, a visiting order, a progress direction, a movement speed, and an environment sound.

13. The information processing apparatus of claim 11, wherein the grouping unit groups the plurality of terminal nodes based on a commonality of the time range data or a commonality of the position range data between the plurality of terminal nodes.

14. The information processing apparatus of claim 1, wherein the acquired information comprises user preference information pertaining to locations along routes of travel of the plurality of terminal nodes.

15. The information processing apparatus of claim 1, further comprising:
a communication unit configured to allow communications between terminal nodes of the plurality of terminal nodes that are grouped within a common group.

16. The information processing apparatus of claim 15, wherein the communication unit notifies each terminal node of the terminal nodes that are grouped within the common group of a recommended event or location for travel, based on the information acquired from the terminal nodes that are grouped within the common group.

17. The information processing apparatus of claim 15, wherein the communication unit notifies each terminal node of the terminal nodes that are grouped within the common group of a recommended future event or future travel route, based on the information acquired from the terminal nodes that are grouped within the common group.

18. The information processing apparatus of claim 15, wherein the communication unit facilitates communications between terminal nodes that are grouped within the common group to allow transfer of at least one of an image data and a message data between the terminal nodes within the common group.

19. An information processing method comprising:
acquiring information from a plurality of terminal nodes;
analyzing the acquired information and generating route information for each individual one of the plurality of terminal nodes; and
grouping the plurality of terminal nodes based on the route information.

20. A non-transitory computer-readable medium embodied with a program, which when executed by a computer, causes the computer to perform a method comprising:
acquiring information from a plurality of terminal nodes;
analyzing the acquired information and generating route information for each individual one of the plurality of terminal nodes; and
grouping the plurality of terminal nodes based on the route information.
